(19) United States
(12) Patent Application Publication
(10) Pub. No.: US 2004/0043755 A1
(43) Pub. Date: Mar. 4, 2004

(54) Communication quality setting apparatus

(76) Inventors: Kenichi Shimooka, Yokohama (JP); Hiroshi Furukawa, Sagamihara (JP); Daisuke Shinohara, Yokohama (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/234,466

(22) Filed: Sep. 5, 2002

(30) Foreign Application Priority Data
Aug. 27, 2002 (JP) 2002-246094

(51) Int. Cl. H04M 1/66

(52) U.S. Cl. 455/410

(57) ABSTRACT

A communication quality setting apparatus for guaranteeing communication quality of a computer to each storage area of a storage device in consideration of configuration of the storage device and a performance of each component. The apparatus includes a guaranteed performance generating unit for determining a performance value to be guaranteed for each storage area based on request information on guarantee of communication quality, a performance value to be guaranteed for an interface of the storage device, and a performance value to be guaranteed of the storage area of the storage device. The apparatus includes a guaranteed performance setting unit for guaranteeing quality of communication between the computer and the storage area by instructing a storage control unit to control location of data between the storage area and the interface according to the performance value to be guaranteed.

### BACKGROUND OF THE INVENTION

The present invention relates to an apparatus, a method and a program of guaranteeing communication quality in an information processing system. More particularly, the invention relates to technology of guaranteeing the communication quality in a storage network system.

In recent days, a storage network system is likely to reach a significant role. The storage network system is used for directly connecting a large-scaled storage device to a network. As its example, SAN (Storage Area Network) or NAS (Network Attached Storage) have been proposed.

FIG. 15 illustrates an exemplary system arrangement of a storage network system in which a computer 10 uses a storage area 32 in a storage device 30. The storage device 30 includes a plurality of ports 31 served as interfaces through which they may be connected with the network, a plurality of storage areas 32, and a storage control unit 33 for controlling location of data from the computer 10 to the storage area 32.

On the other hand, conventionally, QoS (Quality of Service) guaranteeing technology has been proposed as the technology of guaranteeing quality of communication between the computers 10 on the network or communication between the computer 10 and the port 31. This technology is served as satisfying a request by securing a communication resource such as a band width on the network or processing packets in advance of another communication with respect to an inter-application communication like an internet phone or motion picture streaming that requests constant quality of communication as to a delay time or data loss rate.

As a representative example of QoS guaranteeing technology, RSVP (Resource ReserVation Protocol) regulated in RFC2205 may be referred. This technology is served to guarantee the quality of communication by sending a packet of requesting the QoS guarantee before data is transferred between computers and pre-securing communication resources such as a band width that meet a request in each network relay device located on the communication path between the computers.

The foregoing conventional QoS guaranteeing technology is an implementation of guaranteeing communication quality on the network between the computers. It does not realize the guarantee of communication quality in data communication between the computer 10 and the storage area 32 shown in FIG. 15.

Hence, in order to guarantee the quality of data communication between the computer 10 and the storage area 32, a communication administrator has been required to calculate such a performance value to be guaranteed as satisfying the communication quality to be guaranteed between the computer 10 whose communication quality is to be guaranteed and the storage area 32 by associating with the information about the QoS guaranteeing request, configuration of the storage device, and the performance of each component and then to set the storage control unit 33 so that the communication quality may be guaranteed according to a calculated performance value to be guaranteed.

In order to calculate the performance value to be guaranteed, the communication administrator has been requested to grasp information about the arrangement of connections between the computers 10 and the storage areas 32 in a multi-to-multi manner as well as information about the performance of each device including the storage device 30. It means that it has been difficult to substantially guarantee the quality of communication from the computer to the storage device. In particular, information about the performance value of each device including the storage device 30 may be often changed every moment. Hence, it is more difficult to grasp the information about the performance value of each device including the storage device 30. In actual, no substantial quality guarantee of the communication is allowed between the computers and the storage areas of the storage device.

### SUMMARY OF THE INVENTION

It is an object of the present invention to guarantee the quality of communication between the computers and the storage areas of a storage device in consideration of the performance value of each component included in the storage device.

In carrying out the object, according to an aspect of the invention, an apparatus of setting the communication quality is arranged to guarantee the quality of communication of a storage network system including storage devices which contain storage areas allocated for storing data, interfaces through which data is transferred, and storage control units for controlling location of data between the storage areas and the interfaces, and computers for writing and reading data on and from the storage area. Herein, the apparatus of setting the communication quality includes a guaranteed performance generating unit for determining a performance value to be guaranteed in each of the storage areas based on request information on communication quality guarantee, a performance value each interface of a storage device has, and a performance value each storage area of the storage device has. Further, the apparatus of setting the communication quality includes a guaranteed performance setting unit for guaranteeing the quality of communication between each computer and each storage area of the storage device by instructing the storage control unit to control location of data between the storage area and the interface according to the performance to be guaranteed.

Moreover, in the foregoing apparatus of setting the communication quality, it is preferable that the guaranteed performance generating unit is served to determine a performance value to be guaranteed in each storage area when one or more performance values of the storage areas in the storage device or one or more performance values of the storage areas in the storage device is changed, and then the guaranteed performance setting unit is served to instruct the storage control unit to control location of data between the storage area and the interface according to the performance value to be guaranteed.

In the foregoing apparatus of setting the communication quality, it is preferable that the guaranteed performance setting unit is served to instruct the storage control unit to terminate the quality guarantee of the communication when a certain length of time is passed since the quality guarantee of the communication is started.

Further, in the foregoing apparatus of setting the communication quality, it is preferable that the guaranteed performance setting unit is served to instruct the storage control unit to terminate the quality guarantee of the communication if a time when no data is transferred on the communication path to be guaranteed exceeds a certain length of time.

Other objects, features and advantages of the invention will become apparent from the following description of the embodiments of the invention taken in conjunction with the accompanying drawings.

### BRIEF DESCRIPTION OF THE DRAWINGS

FIG. 1 is a system block diagram showing a storage network system according to the first embodiment of the invention;

FIG. 2 is a table showing data to be passed from a QoS reading unit 41 to a guaranteed performance value generating unit 43 in the first embodiment;

FIG. 3 is a table showing data to be passed from a storage control information reading unit 42 to the guaranteed performance generating unit 43 in the first embodiment;

FIG. 4 is a table showing data to be passed from the guaranteed performance generating unit 43 to a guaranteed performance setting unit 44 included in the first and the second embodiments;

FIG. 5 is a flowchart illustrating a flow of process of the guaranteed performance generating unit 43 included in the first embodiment;

FIG. 6 is a system block diagram showing a storage network system of the second embodiment corresponding to that of the first embodiment;

FIG. 7 is a table showing data to be passed from the QoS reading unit 41 to the guaranteed performance generating unit 43 included in the second embodiment;

FIG. 8 is a table showing data to be passed from the storage control information reading unit 42 to the guaranteed performance generating unit 43 included in the second embodiment;

FIG. 9 is a flowchart illustrating a flow of process of the guaranteed performance generating unit 43 included in the second embodiment;

FIG. 10 is a system block diagram showing a storage network system of the third embodiment corresponding to that of the first embodiment;

FIG. 11 is a block diagram showing a storage device 30 included in the third embodiment;

FIG. 12 is a table showing data to be passed from the QoS reading unit 41 to the guaranteed performance generating unit 43 included in the third embodiment;

FIG. 13 is a table showing data to be passed from the storage control information reading unit 42 to the guaranteed performance generating unit 43 included in the third embodiment;

FIG. 14 is a table showing data to be passed from the guaranteed performance generating unit 43 to the guaranteed performance setting unit 44 included in the third embodiment; and

FIG. 15 is a block diagram showing a storage system having a storage device being directly connected with a network.

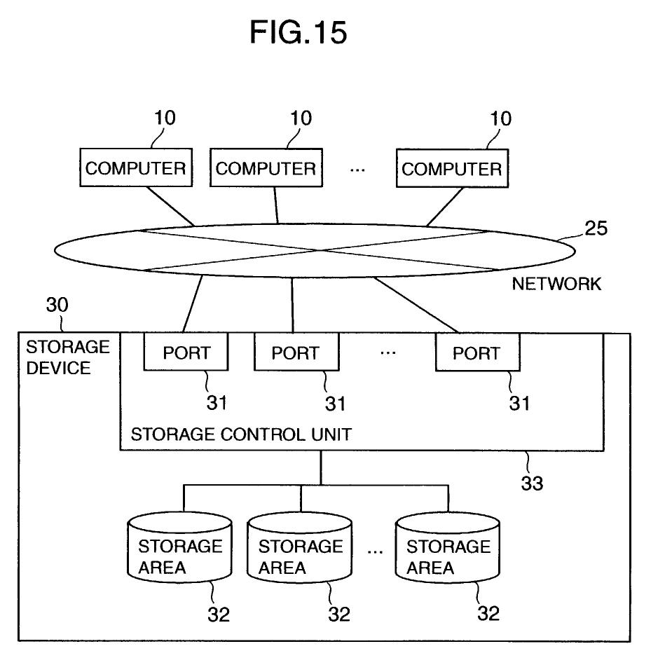

### DESCRIPTION OF THE EMBODIMENTS

(First Embodiment)

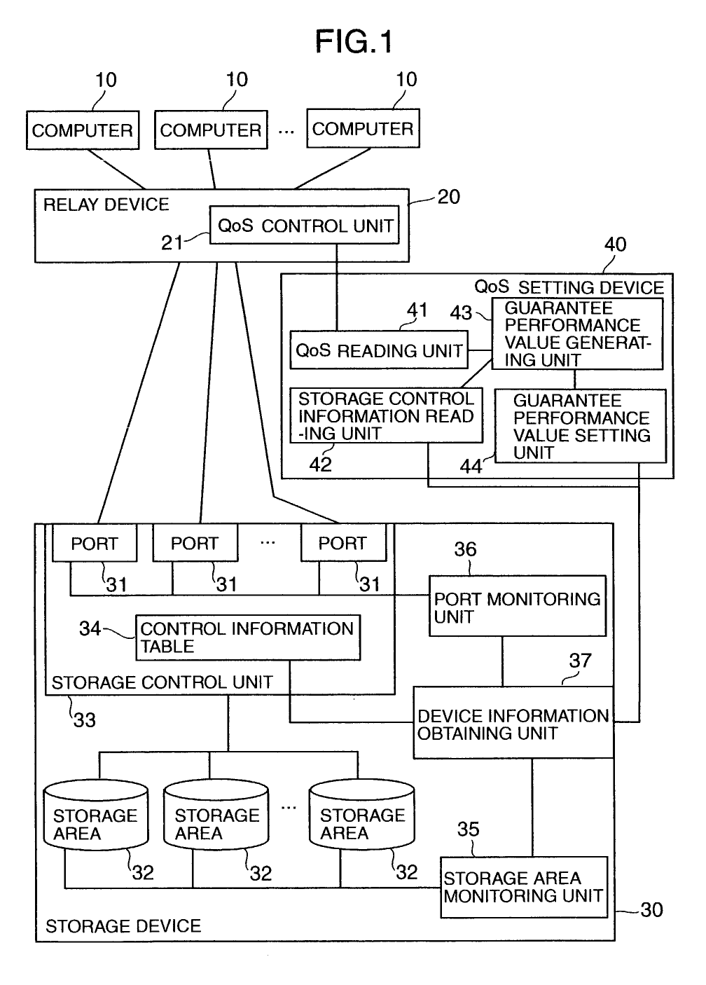

FIG. 1 is a block diagram showing a system arrangement of a storage network system according to the present embodiment of the invention.

The storage network system of the first embodiment includes a plurality of computers 10, a relay device 20, a storage device 30, and a QoS setting device 40. In this embodiment, the QoS setting device 40 is illustrated as an independent device. In actual, it may be provided inside the storage device 30.

The relay device 20 includes a connection control unit of controlling a connecting relation between the computers 10 and a storage device 30, and a QoS control unit 21 of realizing the quality guarantee of the communication between the computers 10 and the storage device 30. The relay device 20 may be a router or a gateway, for example. In this embodiment, only one relay device 20 is located between the computers 10 and the storage device 30. Two or more relay devices may be located therebetween.

The QoS setting device 40 includes a QoS reading unit 41 of recording a guarantee-requested performance value on each communication route to which the value is inputted through a network management terminal, a storage control information reading unit 42 of obtaining a performance value to be guaranteed in a port 31 inside the storage device 30 and a performance value to be guaranteed in a storage area 32 inside the storage device 30, a guaranteed performance generating unit 43 of determining a performance to be guaranteed on the basis of the guarantee-requested performance value, the performance value to be guaranteed in the port 31 inside the storage device 30, and the performance value to be guaranteed in the storage area 32 inside the storage device 30, and a guaranteed performance setting unit 44 of instructing the storage control unit 33 to control location of data between the port inside the storage device and the storage area so as to guarantee the performance value to be guaranteed.

In this and the other embodiments, a program functioned as the QoS reading unit 41, the storage control information reading unit 42, the guaranteed performance generating unit 43 or the guaranteed performance setting unit 44 is stored on a recording medium such as a CD-ROM and then saved on a magnetic disk or the like. Next, the program is loaded onto the memory of the QoS setting device 40 and then is executed. The medium on which the program is to be stored may be another storage medium other than the CD-ROM. Further, the program may be installed from the storage medium to the memory of the QoS setting device 40 or be used by accessing the storage medium through the network.

Herein, description will be oriented to the flow of process of the storage control information reading unit 42 included in the QoS setting device 40.

The storage control information reading unit 42 instructs the device information obtaining unit 37 to measure the maximum performance value to be guaranteed by each of the ports 31 and the storage areas 32 inside the storage device 30. In addition, if a value is pre-indicated as a performance value of the port 31 or the storage area 31, the storage control information reading unit 42 may use the value as a performance value of the port 31 or the storage area 32 as the maximum performance value to be guaranteed.

The storage control information reading unit 42 is served to receive a maximum performance value to be guaranteed in each port 31 and each storage area 32 from the device information obtaining unit 37, recording on a port performance table 110 the maximum performance value 112 to be guaranteed in the port 31 to be identified by each port ID 111, and then record on a stored area performance table 120 a maximum performance value 122 to be guaranteed in the storage area 32 to be identified by each storage area ID 121.

Moreover, the storage control information reading unit 42 instructs the device information obtaining unit 37 to obtain failure information of a port sensed by a port monitoring unit 36.

The storage control information reading unit 42 instructs the device information obtaining unit 37 to obtain failure information of the storage area sensed by the storage area monitoring unit 35.

The storage control information reading unit 42 is served to record the maximum performance value 112 to be guaranteed in the port 31 whose failure is sensed as zero (0) in the port performance table 110.

The storage control information reading unit 42 is served to record the maximum performance value 112 to be guaranteed in the storage area 32 whose failure is sensed as zero (0) in the storage area performance table 120.

The storage device 30 includes the port 31 served as a communication interface with the relay device 20, the storage area 32 of holding data, a storage control unit 33 of executing access control of location of the data between the port 31 and the storage area 32 according to the control information table 34 having a data location map of the port 31 and the storage area 31 recorded thereon, a storage area monitoring unit 35 of obtaining a performance value of each storage area 31 or sensing a failure, a port monitoring unit 36 of obtaining a performance value of each port 31 and sensing a failure thereof, and a device information obtaining unit 37 of obtaining arrangement information of the storage device 30. The storage area 32 may record data on a data block unit or a file unit. Or, it may be treated as a physical storage area or a logical storage area. Further, the device information obtaining unit 37 may be realized on the port 31. Moreover, the storage control unit 33, the storage area monitoring unit 35 or the port monitoring unit 36 may be located outside of the storage device.

The QoS setting device 40 includes a QoS reading unit 41 of obtaining QoS guarantee request information on the communication quality on each communication route between the computer 10 and the storage device 30 from the QoS control unit 21, the storage control information reading unit 42 of obtaining a maximum performance value 112 to be guaranteed in the port 31 of the storage device 30 and a maximum performance value 122 to be guaranteed in the storage area 31 from the device information obtaining unit 37 of the storage device 30, the guaranteed performance generating unit 43 of calculating the performance values 133 and 143 to be guaranteed on each communication route between the computer 10 and the storage area 32 of the storage device 30, and the guaranteed performance setting unit 44 of instructing the storage device 30 or the relay device to guarantee the computed performance values 133 and 143.

The QoS reading unit 41 obtains the guarantee request information on each communication route from the QoS control unit 21.

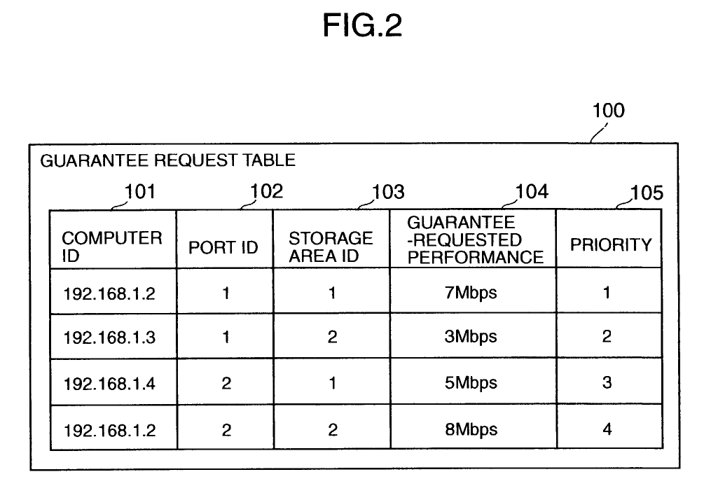

FIG. 2 shows the content of the guarantee request table 100 according to this embodiment.

The guarantee request table 100 includes a computer ID 101, a port ID 102 by which the port 31 of the storage device 30 is to be identified, a storage area ID 103, a guarantee-requested performance value 104 on each communication route specified by the computer ID, the port ID 102 and the storage area ID 103, and a priority 105 on each specified communication route.

The computer ID 101 is an ID of the computer 10, which is represented by an IP (Internet Protocol) address, an MAC (Media Access Control) address, a WWN (World Wide Name), and so forth.

The port ID 102 is an ID by which the port 31 is uniquely identified inside the storage area 30.

The storage area ID 103 is an ID by which the storage area 31 is uniquely identified inside the storage device 30. Each device may specify the communication route through the use of the storage area ID 103, the computer ID, the port ID 102, and the storage area ID 103.

The guarantee-requested performance value 104 is a performance value including a band width, a delay time or a data loss ratio being guaranteed between the computer 10 and the port 31 by the relay device 20. The guarantee-requested performance value 104 is a performance value on each path (route) among the computer 10 represented by the computer ID 101, the port 31 represented by the port ID 102 and the storage area 32 represented by the storage area ID 103. In addition, the network administrator enables to set the QoS control unit 21 to set the guarantee-requested performance value 104 through the GUI of the relay device 20.

The priority 105 represents the priority sequence of communication quality guarantee on each communication route. In addition, the network administrator enables to set the priority 105 to the QoS control unit 21 through GUI of the relay device 20. Further, if no priority 105 is set to the QoS control unit 21, any priority 105 may have the same value.

The storage control information reading unit 42 obtains the port performance table 110 and the storage area performance table 120 from the device information obtaining unit 37 and stores the tables in itself.

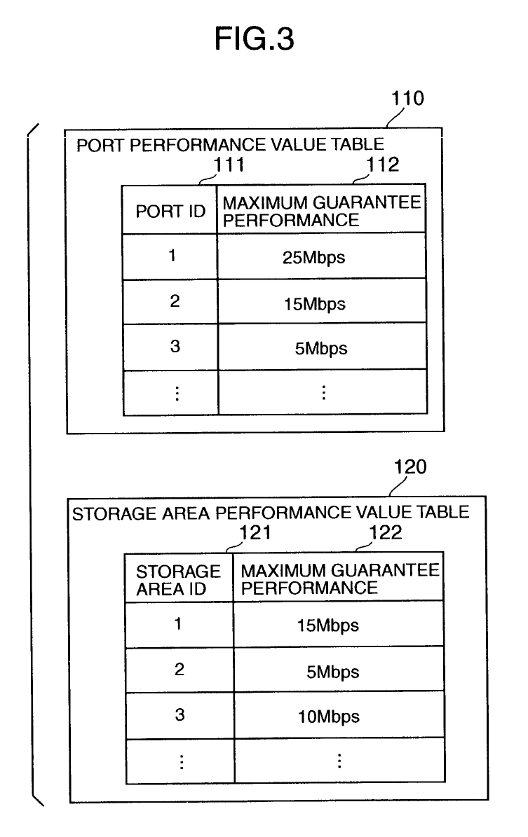

FIG. 3 shows the contents of the port performance table 110 and the storage area performance table 120 included in this embodiment.

The port performance table 110 records the port ID 111 and the guaranteed maximum performance value 112 of the communication to be executed through each port 31 for each port ID.

The storage area performance table 120 records each storage area ID 121 and the maximum performance value 122 to be guaranteed on the overall communication to each storage area 32 for each storage areas ID 121.

The guaranteed performance generating unit 43 calculates the performance values 133 and 143 to be guaranteed on each communication route of the computer 10 to the storage area 32 of the storage device 30 on the basis of the guarantee request table 100, the port performance table 110 and the storage area performance table 120. The guaranteed performance setting unit 44 instructs the relay device 20 and the storage control device 30 so as to control access between the port 31 and the storage area 32 according to the port QoS table 130 or the storage area QoS table 140 created by the guaranteed performance generating unit 43.

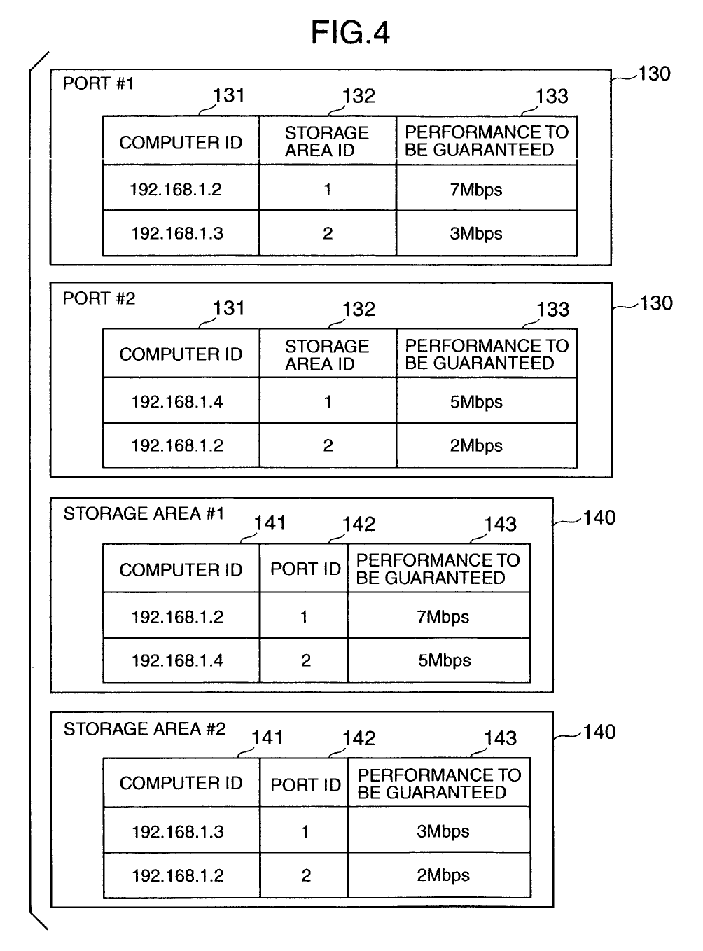

FIG. 4 shows the contents of the port QoS table 130 and the storage area QoS table 140 according to this embodiment.

The port QoS table 130 stores a computer ID 131, a storage area ID 132, and a performance value 133 to be guaranteed to the storage area 32 specified on the communication route between the computer 10 specified by the computer ID 131 and the storage area 32 specified by the storage area ID 132.

The storage area QoS table 140 stores a computer ID 141, a port ID 142 for identifying the port of the storage device 30, and a performance value 143 to be guaranteed to the port 31 specified on the communication route between the computer 10 specified by the computer ID 131 and the port 31 specified by the port ID 142.

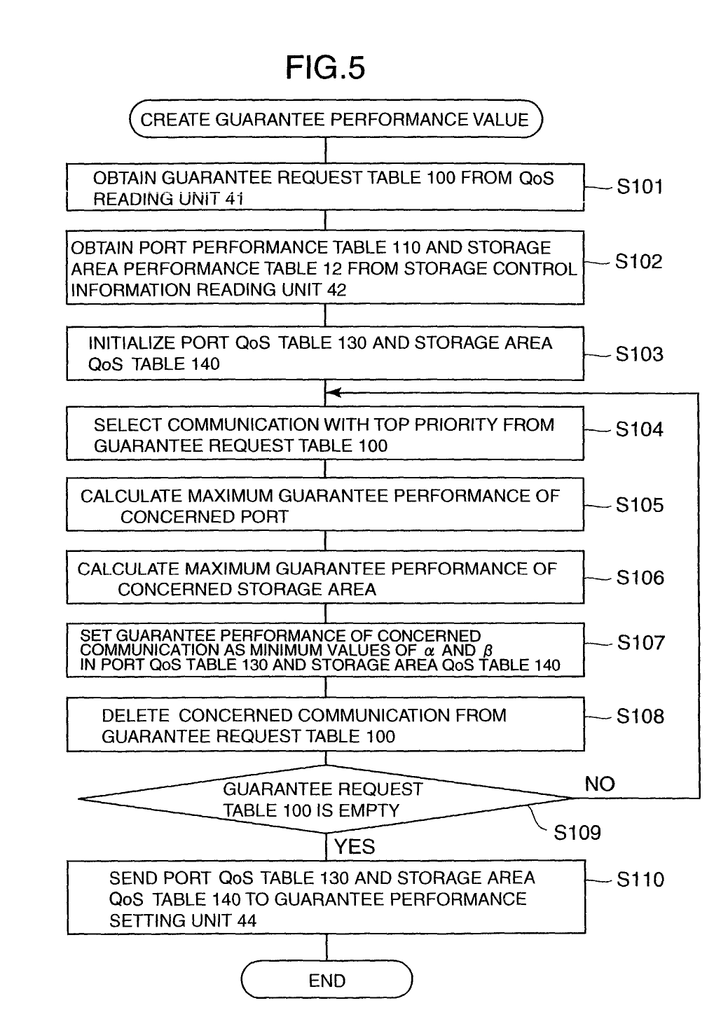

FIG. 5 is a flowchart showing a flow of process of the guaranteed performance generating unit 43 according to this embodiment.

The guaranteed performance generating unit 43 obtains the guarantee request table 100 shown in FIG. 2 from the QoS reading unit 41 (S101).

The guaranteed performance generating unit 43 obtains the port performance table 110 and the storage area performance table 120 from the storage control information reading unit 42 (S102).

The guaranteed performance generating unit 43 initializes the content of the port QoS table 130 and the content of the storage area QoS table 140 (S103).

The guaranteed performance generating unit 43 specifies the communication with the highest priority 105 by the combination of the computer ID 101, the port ID 102 and the storage area ID 103, based on the guarantee request table 100 (S104).

The guaranteed performance generating unit 43 specifies the maximum performance value 112 to be guaranteed of the port 32 of the storage device identified by the port ID 102 of the communication route specified in the step S104, based on the port performance table 110 (S105).

The guaranteed performance generating unit 43 specifies the maximum performance value 122 to be guaranteed of the storage area 32 identified by the storage area ID 103 of the communication route specified in the step S104, based on the storage area performance table 120 (S106).

The guaranteed performance generating unit 43 specifies the guarantee-requested performance value 104 on the communication route specified in the step S104 based on the guarantee request table 100 and derives a minimum value from three values of the guarantee-requested performance value 104, the maximum performance value 112 to be guaranteed in the port 31 specified in the step S105, and the maximum performance value 122 to be guaranteed by the storage area 32 specified in the step S106.

The guaranteed performance generating unit 43 records this minimum value as a performance value to be guaranteed for the communication route specified in the step S104 in the port QoS table 130 and the storage area QoS table 140 (S107). If the performance values 133 and 143 to be guaranteed do not reach the guarantee-requested performance value 104, it is recognized as an error and the quality guarantee of communication against the communication route may be stopped.

If the performance value 133 to be guaranteed for the port on the specified communication route is recorded in the step S107, the guaranteed performance generating unit 43 rewrites the port performance table 110 so that the value derived by subtracting the performance value 133 to be guaranteed from the maximum performance value 112 to be guaranteed for the port 31 of the port performance table 110 may be the maximum performance value 112 to be guaranteed.

Likewise, if the performance value 143 to be guaranteed to the storage area 32 on the specified communication route is recorded in the step S107, the guaranteed performance generating unit 43 rewrites the storage area performance table 120 so that the value derived by subtracting the performance value 143 to be guaranteed from the maximum performance value 122 to be guaranteed for the storage area 32 of the storage area performance table 120 may be the maximum performance value 122 to be guaranteed.

The guaranteed performance generating unit 43 deletes the data on the communication roue specified in the step S104 from the guarantee request table 100 (S108).

The guaranteed performance generating unit 43 specifies the communication route with the next highest priority and repeats the processes of the steps S104 to S108 until the data of the guarantee request table 100 is made empty (S109).

The guaranteed performance generating unit 43 sends the port QoS table 130 and the storage area QoS table 140 to the guaranteed performance setting unit 44 (S110).

Herein, description will be oriented to the flow of process of the QoS reading unit 41.

The QoS reading unit 41 periodically obtains information on a request for the quality guarantee of communication between the computer 10 and the port 31 from the QoS control unit 21. In a case that the arrangement of the storage control unit 33 or the storage areas 32 is changed in the storage device 30, in a case that the performance values of the port 31 and the storage area 32 are changed in the storage device, in a case that a failure takes place in the port 31 or the storage area 32, or in a case that the content of the guarantee request table 100 is changed, the QoS control unit 21 may notify the QoS reading unit 41 of the information on the request for the quality guarantee of the communication.

The QoS reading unit 41 records the guarantee-requested performance value 104 and the priority 105 of the communication quality requested for each communication route specified by the computer ID 101, the port ID 102 of the storage device and the storage area ID 103 from the information on the request for the quality guarantee of the communication and then sends the guarantee-requested performance value 104 and the priority 105 to the guaranteed performance generating unit 43.

The QoS setting device 40 may start the process of the guaranteed performance generating unit 43 shown in FIG. 5 on the periodic timing or on the timing when the information on the request for the quality guarantee of communication is received from the QoS control unit 21.

The guaranteed performance setting unit 44 obtains the port QoS table 130 and the storage area QoS table 140 from the guaranteed performance generating unit 43.

The guaranteed performance setting unit 44 creates a control information table 34 so as to execute access control between the port 31 and the storage area 32 according to the obtained port QoS table 130 and storage area QoS table 140 and then sends the control information table 34 to the relay device 20 and the storage control unit 33. In addition, the destination to which the guaranteed performance setting unit 44 sends the control information table 34 may be either one of the relay device 20 and the storage control unit 33.

The storage control unit 33 executes control of accessing data between the port 31 and the storage area 32 according to the control information table 34.

Likewise, the relay device 20 executes control of accessing data between the relay device 20 and the port 31 of the storage device 30 according to the control information table 34.

This makes it possible to secure the communication quality to be guaranteed for each communication route between the computer 10 and each storage area 32 of the storage device 30.

Further, by obtaining the information on the port or the storage area where a failure takes place, the communication passing through the port where the failure takes place may avoid securing a communication resource of the normal storage area. Conversely, the communication passing through the storage area where the failure takes place may avoid securing a communication resource of a normal port.

[Second Embodiment]

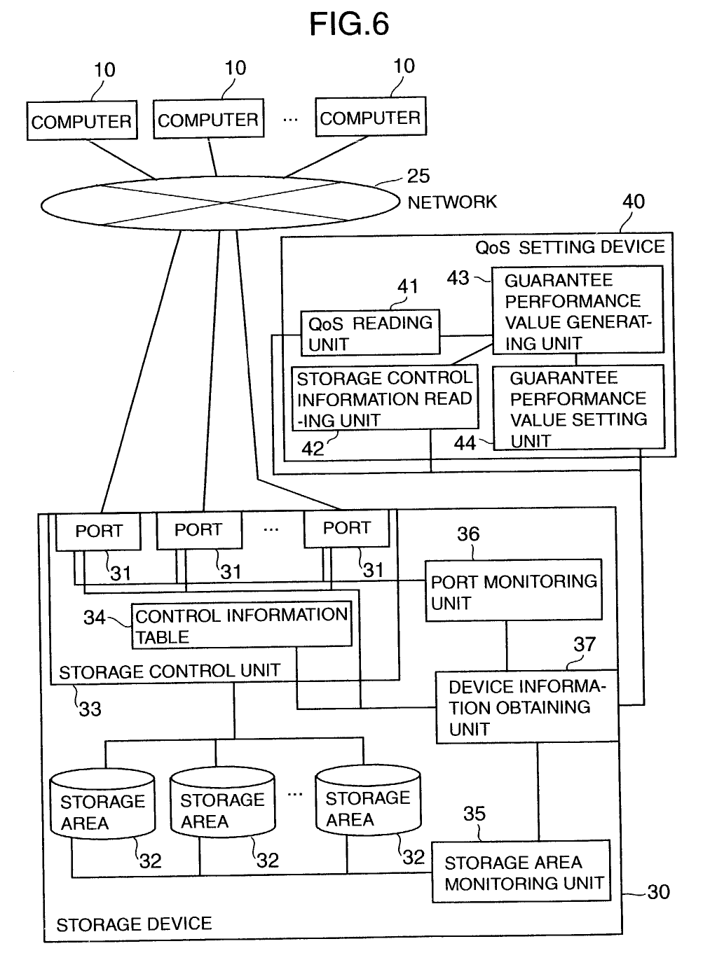

FIG. 6 shows a system arrangement of a storage network system according to this embodiment.

The storage network of this embodiment includes a plurality of computers 10, a network 22 having a relay device, a storage device 30, and a QoS setting device 40.

In the first embodiment, the relay device 20 holds the quality guarantee of the communication between the computer 10 and the port 31. On the other hand, in the second embodiment, the computer 10 sends a communication quality guarantee packet like an RSVP when the communication is executed.

The arrangements of the storage device 30 and the QoS setting device 40 are analogous to those of the first embodiment. However, the different respect of this embodiment from the first embodiment is that the QoS reading unit 41 is provided with means of obtaining the guarantee request information between the computer 10 and the port 31, which corresponds to one piece of device information, not from the QoS control unit 21 but from the device information obtaining unit 37.

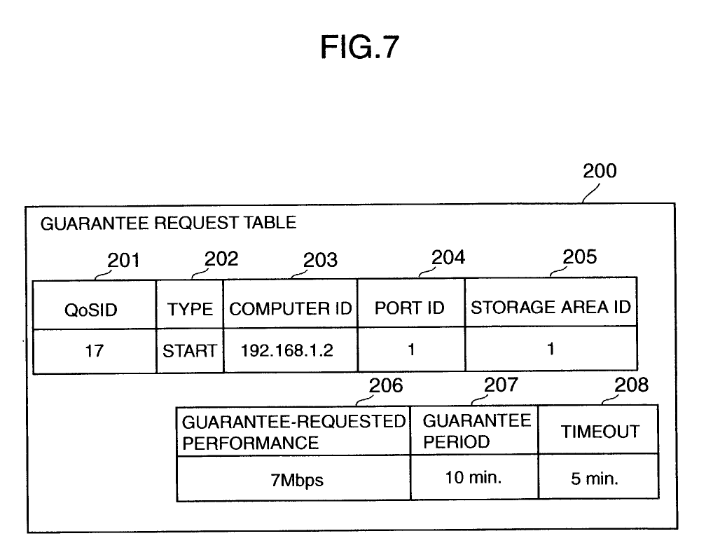

FIG. 7 shows the content of the guarantee request table 200 of this embodiment.

The computer 10 sends the content of the guarantee request table shown in FIG. 7 as the data of a communication quality guarantee packet to the QoS reading unit 41 of the QoS setting device 40 through a network 25.

The QoS reading unit 41 receives the communication quality guarantee packet from the computer 10.

The guarantee request table 200 includes a QoS ID 201, a type 202, a computer ID 203, a port ID 204, a storage area ID 205, a guarantee-requested performance value 206, a guarantee period 20, and a timeout 208 recorded therein.

The QoS ID 201 is an identifier for each communication route whose quality is guaranteed. For example, it is represented by a communication connection ID or a packet ID.

The type 202 is data of representing if the quality guarantee of the communication is started or terminated.

The communication route whose quality is to be guaranteed is specified by the computer ID 203, the port ID 204 and the storage area 205.

The guarantee-requested performance value 206 indicates a performance value the network administrator enters and requests to the relay device 20 between each computer 10 and each port 31 of the storage device 30.

The guarantee period 207 represents the time when the guarantee is continued since the quality guarantee of the communication is started.

The timeout 208 means that the quality guarantee of the communication is terminated if no data transfer is executed on the communication route continuously specified during the time given by the timeout 208 itself.

The guarantee period 207 and the timeout 208 are required to prevent the continuous securement of the communication resources such as a band width though a communication quality guarantee packet indicating the end of the communication quality guarantee does not reach the port 31 by the failure of the application on the computer 10 and the network 25. In this embodiment, however, the guarantee period 207 and the timeout 208 are not inevitably included in the guarantee request table 200.

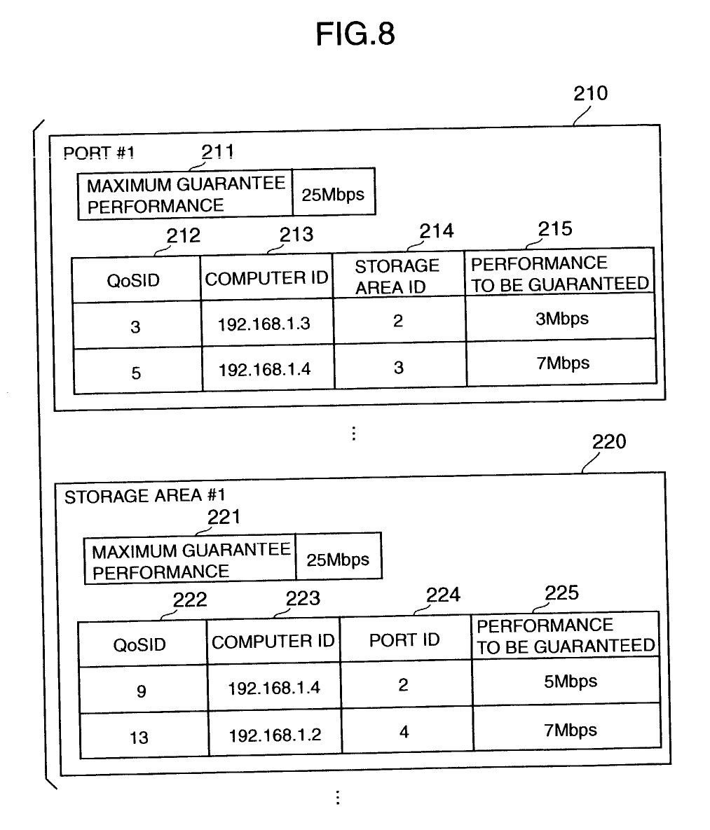

FIG. 8 shows the port QoS data 210, the storage area QoS data 220 included in this embodiment.

The port QoS data 210 represents a QoS ID 212, a computer ID 213, a storage area ID 214, a maximum performance value 211 to be guaranteed for each port 31, and a performance value 215 to be guaranteed for each port of the storage device on the communication route specified by the QoS ID 212.

The storage area QoS data 220 is composed of a maximum performance value 221 to be guaranteed for each storage area 32, a QoS ID 222, a computer ID 223, a port ID 224, and a performance value 225 to be guaranteed for each storage area 32 on the communication route specified by the QoS ID 212.

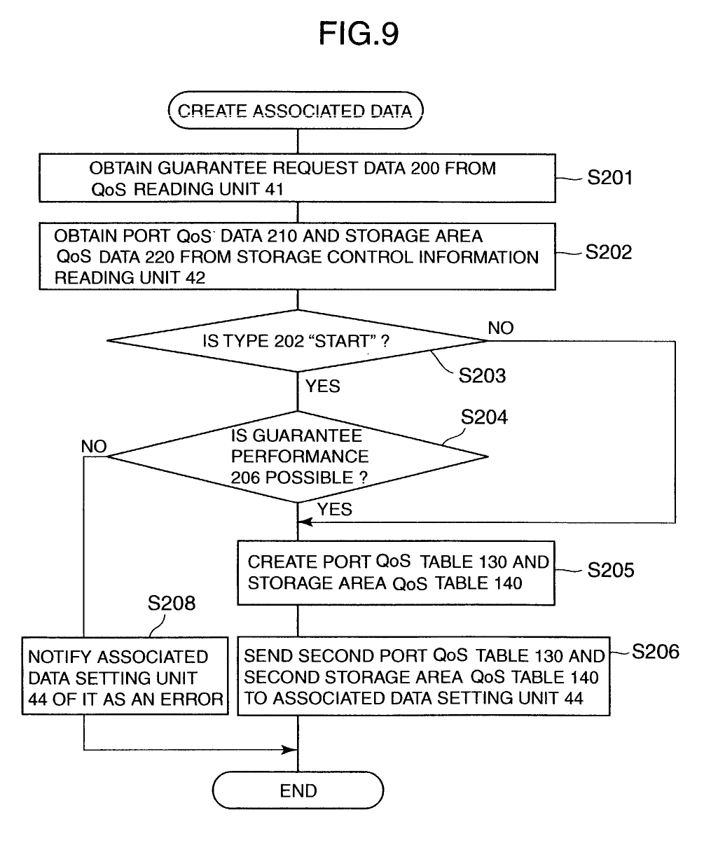

FIG. 9 shows the flow of process of the guaranteed performance generating unit 43 according to this embodiment.

The guaranteed performance generating unit 43 obtains from the QoS reading unit 41 the content of the guarantee request table 200 shown in FIG. 7 as the data of a communication quality guarantee packet and then specify the target of QoS by the QoS ID 201 of the guarantee request table 200 (S201). When the port 31 receives the data of the communication quality guarantee packet, the storage control unit 33 may send the content of the guarantee request table 200 as the data of the communication quality guarantee packet to the guaranteed performance generating unit 43 through the device information obtaining unit 37.

The guaranteed performance generating unit 43 periodically obtains the port QoS data 210 and the storage area QoS data 220 shown in FIG. 8 from the storage control information reading unit 42 (S202). The guaranteed performance generating unit 43 may be arranged to obtain the port QoS data 210 and the storage area QoS data 220 in the case of receiving the data of the communication quality guarantee packet.

The guaranteed performance generating unit 43 determines if the guarantee-requested performance value 206 of the QoS target specified if the type of the QoS target specified in the step S201 is “Start” does not exceed the maximum performance value to be guaranteed for the port specified by the port ID 204 of the specified QoS target and if the guarantee-requested performance value 206 of the QoS target specified in the step S201 does not exceed the maximum performance 15 value to be guaranteed for the storage area 32 specified by the storage area ID 205 of the specified QoS target (S204).

If either one of them exceeds the value, the guaranteed performance generating unit 43 notifies the guaranteed performance setting unit 44 of it as an error (S208).

If neither of them exceed the values, the guaranteed performance generating unit 43 records the guaranteed request performance value 206 as the performance values 215 and 225 to be guaranteed of the QoS target specified in the step S201 in the port QoS data 210 and the storage area QoS data 220 (S205).

Like the first embodiment, the guaranteed performance generating unit 43 also may record in the port QoS data 210 and the storage area QoS data 220 the minimum value of the guarantee-requested performance value 206 of the QoS target, the maximum performance value to be guaranteed of the port 31, and the maximum performance value to be guaranteed of the storage area 32 as the performance value 215 to be guaranteed of the QoS target specified in the step S201.

On the other hand, if the type 202 of the QOS target specified in the step S201 is “End”, the guaranteed performance generating unit 43 deletes the data 212 to 215 of the specified QoS target from the port QoS data 210 and the storage area QoS data 220 (S205). If the type 202 is “End”, the guaranteed performance generating unit 43 may instruct the relay device and the storage control unit 33 included in the network 25 to terminate the QoS for the communication route specified by the QoS ID 201 through the guaranteed performance setting unit 44.

Next, in a case that the type 202 of the QoS target specified in the step S201 is “Start”, the guaranteed performance generating unit 43 rewrites the port QoS data 210 so that a value derived by subtracting the performance value 215 to be guaranteed from the maximum performance value 211 to be guaranteed of the port ID 204 of the QoS target specified in the step S201 may be a maximum performance value 211 to be further guaranteed by the port 31 represented by the port ID 204.

Likewise, in a case that the type 202 of the QoS target specified in the step S201 is “Start”, the guaranteed performance generating unit 43 rewrites the storage area QoS data so that the value derived by subtracting the performance value 225 to be guaranteed from the maximum guaranteed performance value 221 of the storage area ID 205 of the QoS target specified in the step S201 may be a maximum performance value 221 to be further guaranteed by the storage area 32 represented by the storage area IS 205.

The guaranteed performance generating unit 43 sends the port QoS data 210 and the storage area QoS data 220 to the guaranteed performance setting unit 44 (S206).

In addition, the guaranteed performance generating unit 43 may be arranged to send not all the port QoS data 210 and the storage area QoS data 220 but only a changed part of the data as compared with the previously sent content.

The guaranteed performance setting unit 44 obtains the port QoS data 210 and the storage area QoS data 220 from the guaranteed performance generating unit 43.

The guaranteed performance setting unit 44 creates the content of the control information table so as to control the access between the port 31 and the storage area 32 according to the port QoS data 210 and the storage area data 220, and then sends the created content to the relay device included in the network 25 and the storage control unit 33. The guaranteed performance setting unit 44 may be arranged to send the content of the control information table 34 to either one of the relay device included in the network 25 and the storage control unit 33 as a destination.

The storage control unit 33 executes the control of accessing data between the port 31 and the storage area 32 according to the control information table 34.

Likewise, the relay device included in the network 25 executes the control of accessing data between the relay device and the port 31 of the storage device 30 according to the control information table 34. This makes it possible to secure the communication quality to be required for each communication route between the computer 10 and the storage area 32 of the storage device 30.

Further, the guaranteed performance generating unit 43 sends the port QoS data 210 and the storage area QoS data 220 to the guaranteed performance setting unit 44 and then instructs the relay device included in the network 25 or the storage control unit 33 to terminate the quality guarantee of the communication after the guarantee period 207 is passed.

In response to this instruction, the relay device included in the network 25 and the storage control unit 33 terminates the quality guarantee of the communication of the QoS target specified by the QoS ID 212.

Further, the guaranteed performance generating unit 43 records as a QoS start time the time when the port QoS data 210 and the storage area QoS data 220 are sent to the guaranteed performance setting unit 44.

The guaranteed performance generating unit 43 instructs the storage control information reading unit to obtain the time the final data transfer takes place on each communication after the timeout 208 is passed since the QoS start time.

If the time when the final data transfer takes place is later than the QoS start time, the guaranteed performance generating unit 43 resets the final time to the QoS start time. If earlier, the unit 43 instructs the storage control device 33 to terminate the quality guarantee of this communication.

In response to this indication, the relay device included in the network 25 and the storage control unit 33 terminates the quality guarantee of the communication of the QoS target specified by the QoS ID 212. This allows the guaranteed performance generating unit 43 to store the data like the guarantee period 207 and the timeout 208. Hence, if a communication quality guarantee termination packet does not reach the port 31, the continuous use of the communication resources of the port 31 or the storage area 32 may be prevented.

In the foregoing description, when the computer 10 executes the communication, a communication quality guarantee packet is sent to the port 31. Hence, the QoS setting device 40 is provided to guarantee the quality of the communication between the port 31 and the storage area 32 according to the communication quality guarantee packet.

[Third Embodiment]

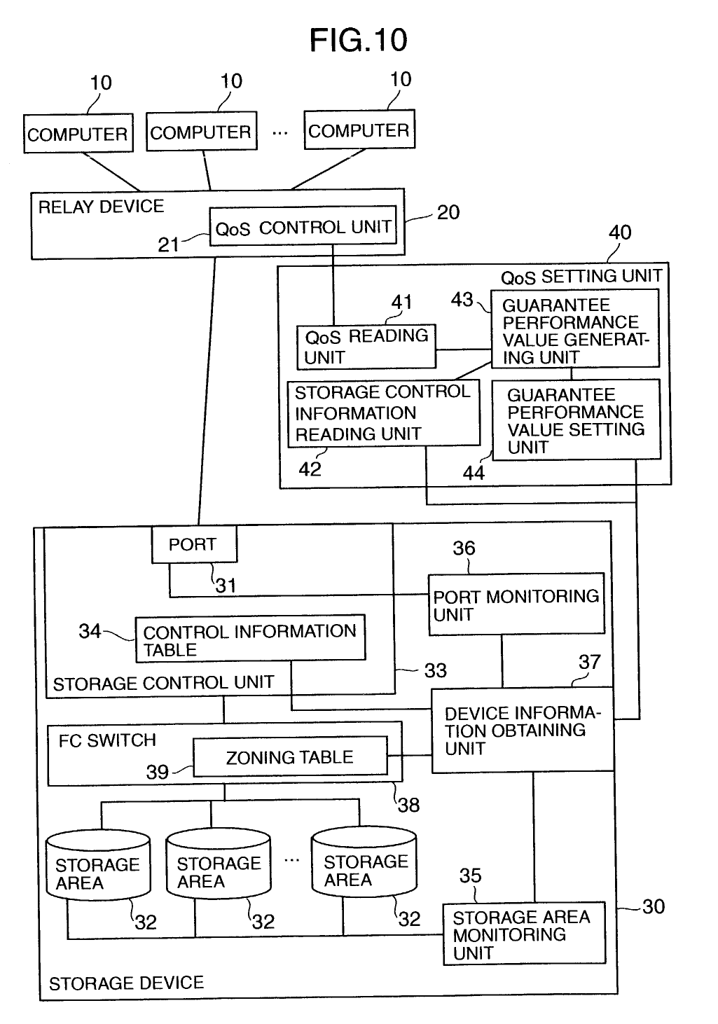

FIG. 10 shows a system arrangement of a storage network system according to this embodiment.

In this embodiment, like the first embodiment, a QoS setting device is provided in the system having a plurality of computers 10, a relay device 20 and a storage device 30.

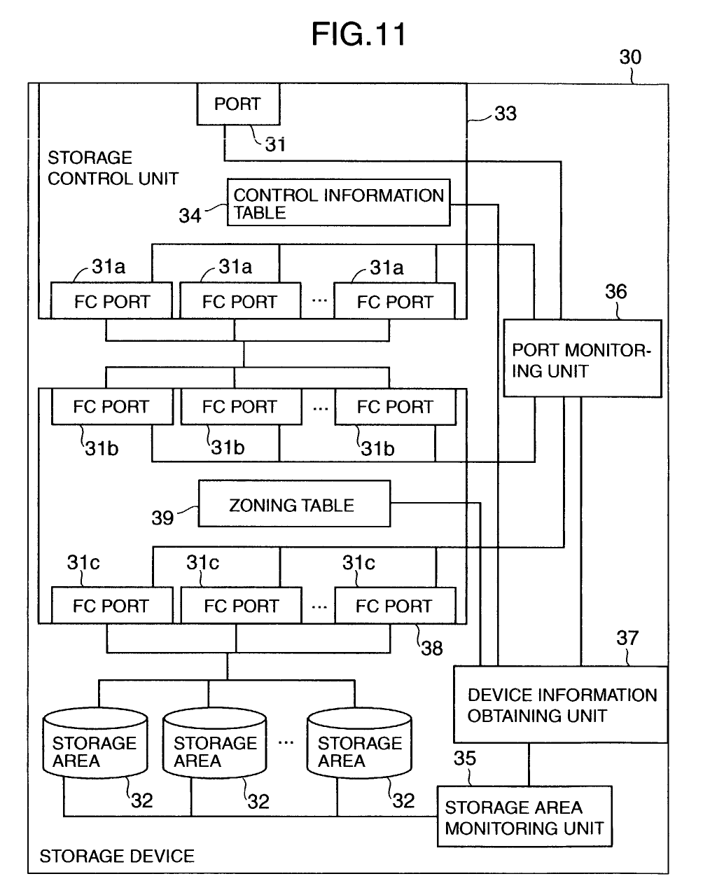

FIG. 11 shows an arrangement of the storage device 30 according to this embodiment.

The arrangement of the storage device 30 includes an FC relay unit 38 having a zoning table 39 that is requisite information to setting the zoning in addition to the arrangement of the first embodiment. In this embodiment, the storage device control unit 33 and the FC relay unit 39 are located inside the storage device 30. In actual, they may be located outside of the storage device 30.

A fibre channel is connected between the storage control unit 33 and the FC relay unit 38 or between the FC relay unit 38 and the storage area 32. The storage control unit 33 and the FC relay unit provides FC ports 31a to 31c served as interfaces to the fibre channel.

Each of the FC ports 31a to 31c and the storage area 31 include WWNs allocated as identifiers thereto.

The zoning table 39 stores information about the zoning held by the FC relay unit 38.

Herein, the zoning is a function of executing communication only between the specific instruments in the FC relay unit. For example, if WWNa, b, c is set to the specific zone, the FC relay unit is served to control so that the instrument with WWNa may be communicated with the instrument with WWNb,c but may not be communicated with the instrument with WWNd.

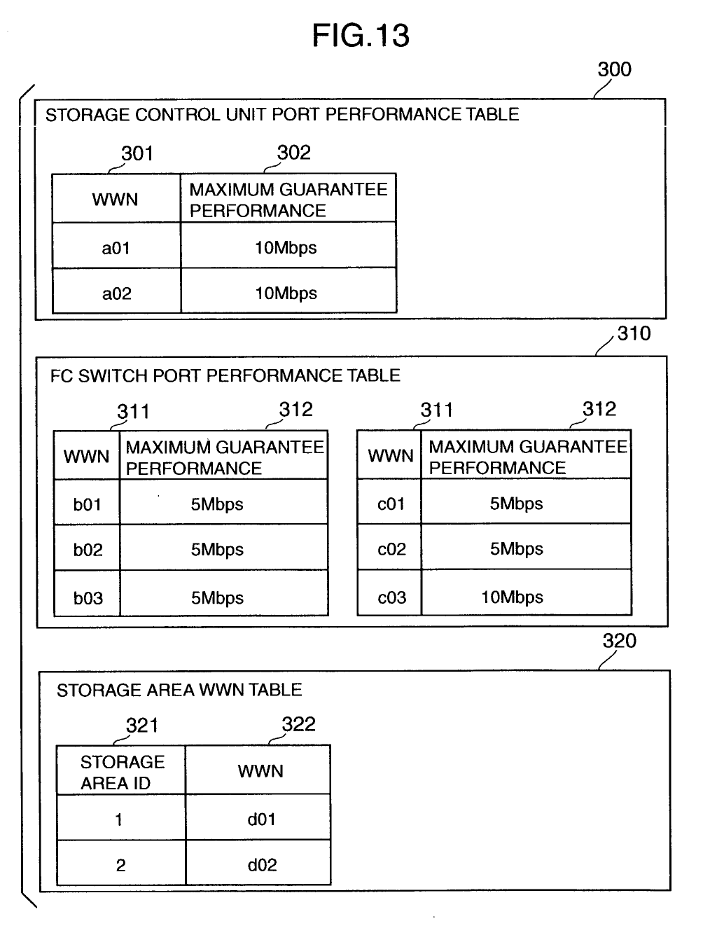

FIG. 13 shows a port performance table 300 of the storage control unit, a port performance table 310 of the FC relay unit, and a WWN table 320 of the storage area.

The port performance table 300 of the storage control unit represents the WWN 301 of the FC port 31a in the storage control unit 33 and the maximum performance value 302 to be guaranteed for each FC port 31a. In actual, the WWN is represented by a 8-byte digit. In the illustration, it is simplified.

The port performance table 310 of the FC relay unit represents the WWN 311 of the FC ports 31b and 31c inside the FC relay unit and the maximum performance value 312 to be guaranteed for each FC port 31b or 31c.

The WWN table 320 of the storage area represents the storage area ID 321 and the WWN 322 of each storage area 32.

Herein, description will be oriented to the flow of process of the guaranteed performance generating unit according to this embodiment.

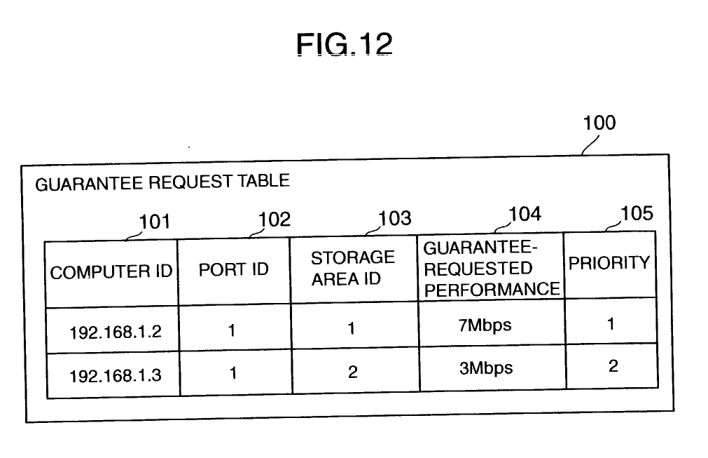

The guaranteed performance generating unit 43 obtains the guarantee request table 100 shown in FIG. 12 from the QoS reading device.

The guaranteed performance generating unit 43 obtains the port performance table 300 of the storage control unit, the port performance table 310 of the FC relay device, and the WWN table 320 of the storage area, all of which are shown in FIG. 13, from the storage control information reading unit 42.

The guaranteed performance generating unit 43 specifies the communication route with the highest priority 105 on the basis of the guarantee request table 100.

The guaranteed performance generating unit 43 specifies one set of WWNs 301 of the FC port that meets the guarantee-requested performance value 104, based on the guarantee-requested performance value 104 and the port performance table 300 of the storage control unit for the specified communication route.

The guaranteed performance generating unit 43 specifies two sets of WWNs 311 of the FC port that meets the guarantee-requested performance value 104, based on the guarantee-requested performance value 104 and the port performance table 310 of the FC relay unit for the specified communication route.

Further, the guaranteed performance generating unit 43 specifies the WWN 322 having the storage area ID 321 equal to the storage area ID 103 of the communication route specified by the WWN table 320 of the storage area, based on the WWN table 320 of the storage area.

The guaranteed performance generating unit 43 combines as one zone the WWN 332 of the storage area for the specified communication route, the WWN 301 of the FC port that meets the specified guarantee-requested performance value 104, and the WWN 31 of the FC port that meets the guarantee-requested performance value 104 and records it in a zone QoS table 340.

Further, the guaranteed performance generating unit 43 specifies WWN 301 of a storage control unit port having a guaranteed performance value 302 satisfying the guarantee-requested performance value 104 with respect to a specified route, based on the guarantee request table 100 and a storage control unit port performance table 300. The unit 43 then records, as WWN 334, WWN 301 of the storage control unit port specified for each of the communication routes specified by the computer ID 331, the port ID 332 and the storage area ID in the FC port QoS table 330.

The guaranteed performance generating unit 43 deletes the WWN recorded on the FC port QoS table 330 from the port performance table 300 of the storage control unit and the port performance table 310 of the FC relay unit. Likewise, the guaranteed performance generating unit 43 deletes the communication route recorded on the FC port QoS table 330 from the guarantee request table 100.

The guaranteed performance generating unit 43 specifies the communication route with the next highest priority based on the guarantee request table 100. Then, the foregoing operation is repeated until the guarantee request table is made empty.

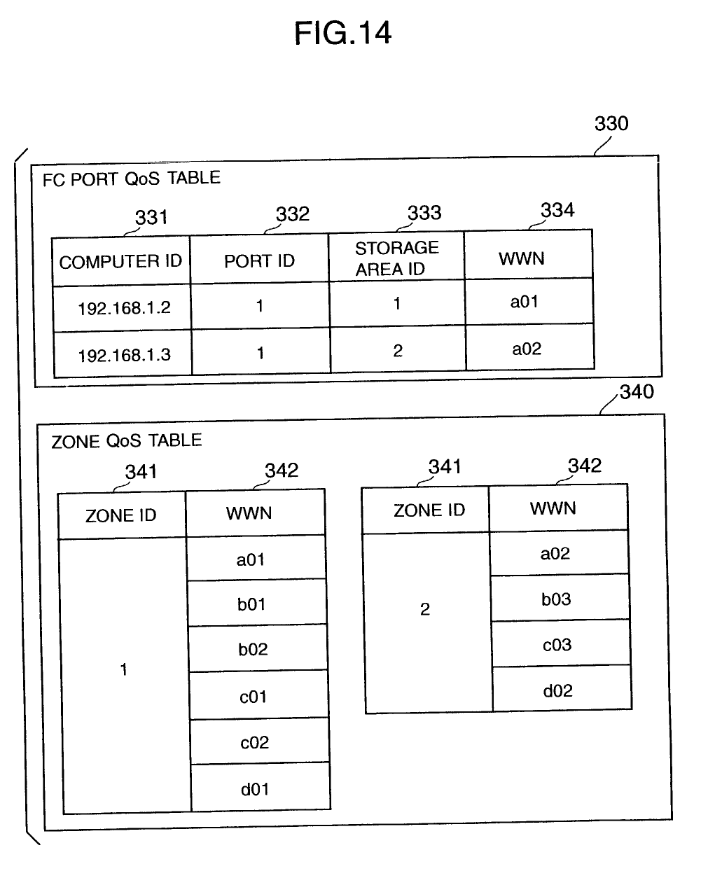

FIG. 14 is a view showing the FC port QoS table 330 and the zone QoS table 340 of this embodiment.

The guaranteed performance generating unit 43 sends the FC port QoS table 330 and the zone QoS table 340 shown in FIG. 14 to the guaranteed performance setting unit 44.

The guaranteed performance setting unit 44 obtains the FC port QoS table 330 and the zone QoS table 340 from the guaranteed performance generating unit 43.

The guaranteed performance setting unit 44 creates the control information table 34 according to the FC port QoS table 330 and sends the table 34 to the storage control unit 33.

The storage control unit 33 controls the location of data between the port 31 and the storage area 32 according to the received control information table 34.

This operation allows the communication route from the computer 10 represented by the computer ID 331 to the storage area 32 represented by the storage area ID 333 to be set to pass through the FC port 31a having the WWN 334 selected to meet the performance value to be guaranteed.

The guaranteed performance setting unit 44 creates the zoning table 39 according to the zone QoS table 340 and then sends the table 39 to the FC relay unit 39.

The FC relay unit 39 sets the zoning according to the received zoning table 39. This makes it possible to set the zone so as to meet the performance value to be guaranteed for each communication route.

The flow of process of the QoS reading unit 41 is analogous to that of the first embodiment. The description on the third embodiment has concerned with the arrangement that the relay device 20 holds the guarantee request table 100 like the first embodiment. In actual, however, like the second embodiment, the third may be applied to the case that the communication quality guarantee packet is sent to the port 31 when the computer 10 executes the communication.

In the foregoing description, if the storage device 30 further provides the FC relay unit 38, the provision of the QoS setting device 40 realizes the quality guarantee of the communication between the computer 10 and the storage area 32.

The present invention makes it possible to guarantee the communication quality between the computer and the storage area of the storage device in consideration of the components of the storage device and the performance values thereof.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An apparatus for setting communication quality, for guaranteeing communication quality of a storage network system including a storage device having one or more storage areas allocated for storing data, one or more interfaces through which said data is to be transferred, a storage control unit for controlling location of data between said each of said storage areas and said interfaces, and a computer for writing and reading data to and from said storage area, comprising:
a guaranteed performance generating unit for determining a performance value to be guaranteed on each of said storage areas, based on request information about the guarantee of communication quality, a performance value to be guaranteed of the interface of said storage device, and a performance value to be guaranteed of the storage area of said storage device; and
a guaranteed performance setting unit for guaranteeing quality of communication between said computer and said storage area of said storage device by instructing said storage control unit to control location of data between said storage area and said interface according to said performance value to be guaranteed.

2. An apparatus for setting communication quality as described in claim 1, wherein said guaranteed performance generating unit determines a performance to be guaranteed for each of said storage areas in a case of changing a performance to be guaranteed of said interface or storage area of said storage device, and
said guaranteed performance setting unit for instructing said storage control unit to control location of data between said storage area and said interface according to said performance value to be guaranteed.

3. An apparatus of setting communication quality as described in claim 1, wherein said guaranteed performance setting unit instructs said storage control unit to terminate quality guarantee of communication when a certain length of time is passed since the quality guarantee of communication is started.

4. An apparatus of setting communication quality as claimed in claim 1, wherein said guaranteed performance setting unit instructs said storage control unit to terminate quality guarantee of communication when the time of data transfer discontinued on a communication path exceeds a certain length of time.

5. A method of setting communication quality, for guaranteeing communication quality of a storage network system including a storage device having one or more storage areas allocated for storing data, one or more interfaces through which said data is to be transferred, and a storage control unit for controlling location of said data between said storage area and said interface and a computer for writing and reading said data to and from said storage area, comprising the steps of:
determining a performance value to be guaranteed of each of said storage areas, based on request information on quality guarantee of communication, a performance value to be guaranteed for said interfaces of said storage device, and a performance value to be guaranteed for said storage areas of said storage device; and
instructing said storage control unit to control location of data between said storage area and said interface according to said performance value to be guaranteed.

6. A program for enabling an apparatus of setting communication quality to guarantee communication quality of a storage network system including a storage device having one or more storage areas allocated for storing data, one or more interfaces through which said data is to be transferred, and a storage control unit for controlling location of said data between said storage area and said interface, and a computer for writing and reading data to and from said storage area, comprising the processes of:
determining a performance value to be guaranteed for each of said storage areas, based on request information on quality guarantee of communication, a performance value to be guaranteed of said interface of said storage device, and a performance value to be guaranteed of said storage area of said storage device; and
instructing said storage control unit to control location of data between said storage area and said interface according to said performance value to be guaranteed.

7. A recording medium for recording a program of enabling an apparatus for setting communication quality to guarantee communication quality of a storage network system including a storage device having one or more storage areas allocated for storing data, one or more interfaces through which said data is to be transferred, and a storage control unit for controlling location of said data between said storage area and said interface, and a computer for writing and reading data to and from said storage area, comprising the processes of:
determining a performance value to be guaranteed for each of said storage areas, based on request information on guarantee of communication quality, a performance value to be guaranteed of said interface of said storage device, and a performance value to be guaranteed of said storage area of said storage device; and
instructing said storage control unit to control location of said data between said storage area and said interface according to said performance value to be guaranteed.

8. A storage network system including a storage device having one or more storage areas allocated for storing data, one or more interfaces through which said data is to be transferred, and a storage control unit of controlling location of said data between said storage area and said interface, a computer for writing and reading data to and from said storage area, and a communication quality setting apparatus for guaranteeing communication quality,
said communication quality setting apparatus having:
a guaranteed performance generating unit for determining a performance value to be guaranteed for each of said storage areas, based on request information on quality guarantee of communication, a performance value to be guaranteed for said storage area of said storage device; and
a guaranteed performance setting unit for guaranteeing communication quality between said computer and said storage area of said storage device by instructing said storage control unit to control location of said data between said storage area and said interface according to said performance value to be guaranteed.
